(19) United States
(12) Patent Application Publication
(10) Pub. No.: US 2026/0157821 A1
(43) Pub. Date: Jun. 11, 2026

(54) Dental Clamping System and Methods

(71) Applicant: Perceptive Technologies, Inc., Boston, MA (US)

(72) Inventors: Justin LaRue, Cambridge, MA (US); Christopher John Ciriello, Boston, MA (US); Phillip Getto, Wellesley, MA (US)

(21) Appl. No.: 19/181,311

(22) Filed: Apr. 16, 2025

Related U.S. Application Data
(60) Provisional application No. 63/634,885, filed on Apr. 16, 2024.
(60) Provisional application No. 63/663,066, filed on Jun. 21, 2024.

(51) Int. Cl. A61C 5/82

(52) U.S. Cl. CPC A61C 5/82

(57) ABSTRACT

A tooth clamp for mounting on, and rigidly clamping to, a plurality of teeth. The tooth clamp includes a buccal side portion, a lingual side portion, at least one tightening mechanism, and a coupling portion. The buccal side portion is disposed on a buccal side, and the lingual side portion is disposed on a lingual side, of the plurality of teeth, when the tooth clamp is mounted thereon. The at least one tightening mechanism is configured to allow a user to progressively bring the buccal and lingual side portions closer together, to thereby engage the plurality of teeth with a desired amount of clamping force. The coupling portion is configured to rigidly couple the clamp to a robotic dental system. Inwardly-facing sides of the buccal and lingual side portions include impression portions, which are shaped as impressions of the buccal side and the lingual side, respectively, of the subject's teeth.

### CROSS REFERENCE TO RELATED APPLICATIONS

This application claims a benefit of U.S. Provisional Patent Application No. 63/634,885, filed 2024 Apr. 16, titled “Dental Clamping System and Methods” and U.S. Provisional Patent Application No. 63/663,066, filed 2024 Jun. 21, titled “Dental Clamping System and Methods,” the entire contents of each of which are hereby incorporated by reference herein, for all purposes.

### BACKGROUND

### Technical Field

The invention relates to dental robotics, and more particularly to dental clamps for attaching dental robots to patient teeth.

### Background

The access to dental care crisis in the United States warrants immediate attention. Over 90% of American adults are affected by dental caries, and approximately 35% of Americans do not visit a dentist annually, with 28% having untreated tooth decay. This widespread dental care avoidance is often attributed to high costs and long appointments. This avoidance contributes to over $45 billion in lost productivity and over 34M lost school hours for young adults and has severe ramifications for individuals' overall health, including increased risks of diabetes, cardiovascular disease, and Alzheimer's disease. The current state of dentistry has numerous challenges, including a heavy reliance on manual procedures that incur high costs and a limited supply of dental practitioners.

### SUMMARY

A need exists for an improved tooth clamp apparatus that can be utilized in a robotic dental system, such as a robotic tooth preparation system. In particular, a need exists for a tooth clamp that can reliably maintain such a robotic dental system in a predictable position and/or orientation relative to a target tooth or target teeth, without impacting patient comfort. A need also exists for a highly accurate robotic dental system that utilizes such a tooth clamp.

The present disclosure addresses the above needs by providing a tooth clamp for mounting on, and rigidly clamping to, a plurality of teeth of a subject, the tooth clamp comprising: a buccal side portion, which is disposed on the buccal side of the plurality of teeth, when the tooth clamp is mounted thereon; a lingual side portion, which is disposed on the lingual side of the plurality of teeth, when the tooth clamp is mounted thereon; at least one tightening mechanism (for example comprising a screw and a correspondingly-threaded hole, a cam, a gear, a ratchet, or any combination thereof), which allows a user to progressively bring the buccal and lingual side portions closer together, to thereby engage the plurality of teeth with a desired amount of clamping force; and a coupling portion, configured to rigidly couple the clamp to a robotic surgery system, wherein an inwardly-facing side of each of the buccal and lingual side portions comprises an impression portion, which is shaped as an impression of the buccal or lingual side, respectively, of the plurality of teeth of the particular subject.

In any embodiment, the impression portions can, for example, be formed by taking physical impressions of the teeth of the specific patient (e.g., by placing impression material, such as a polymer and/or a dental cement, against the teeth of the patient), or can, for example, be formed by imaging the teeth and forming material (e.g., using computer controlled machining, 3D printing, molding, etc.) with a surface geometry that mates with and/or is complementary to the three-dimensional shape of the teeth of the specific patient.

In any embodiment, at least a majority of an apical side of each of the impression portions is exposed to an exterior of the clamp. In addition, or instead, the tooth clamp may comprise at least one opening, which exposes, to an exterior of the clamp, at least an occlusal surface of at least one tooth of the plurality of teeth. The at least one exposed tooth may, for example, comprise a target tooth on which a dental procedure will be performed.

In some examples, the impression portions may be transparent to at least one of: visible light, infrared, or ultraviolet.

In any embodiment, the coupling portion extends from an outward-facing surface of the buccal side portion. In addition, or instead, at least part of each impression portion is shaped as an impression of surfaces of the plurality of teeth that are disposed on a gingival side of a height of contour of the plurality of teeth.

Additionally, or alternatively, the coupling portion is elongated in a length direction that meets the outward-facing surface of the buccal side portion at an oblique or perpendicular angle. The length direction can, for example, have a component directed towards the apical direction.

In any embodiment, the tooth clamp further comprises at least one biasing member, which urges the buccal and lingual side portions away from each other, towards an open configuration of the clamp. In such embodiments, in the open configuration, the buccal and lingual side portions are, for example, spaced apart by a first spacing, and the at least one tightening mechanism is operable when the buccal and lingual side portions are spaced apart by, at most, a second spacing, which is less than the first spacing. The second spacing may, for instance, correspond to the “gapped configuration” as described herein.

In any embodiment, each of the buccal and lingual side portions comprises a frame portion, which holds the impression portion, and the at least one biasing member comprises an arcuate frame portion connected to, or integrally formed with, respective distal ends of the buccal and lingual side portions.

In examples, each of the buccal and lingual side portions comprises a frame portion, which holds the impression portion. In some examples, such frame portions are elongate and/or arcuate, following the shape of the dental arch of the subject that comprises the plurality of teeth. In some examples, each of the buccal and lingual side portions can, for instance, be formed of a first material and each of the impression portions can, for example, be formed of a second, different material. In some examples, the first material is metallic; for instance, it may be a metal or an alloy (e.g., stainless steel). In addition, or instead, the second material can, for example, be polymeric. The second material can, for instance, be a dental cement.

In some embodiments, the impression portions of the buccal and lingual side portions are integrally formed with one another. For example, they may be provided by a single body of polymeric material and/or dental cement.

In any embodiment, the buccal and lingual side portions are integrally formed with their respective impression portions. For instance, the buccal and lingual side portions and their respective impression portions may be formed by molding, machining, or 3D printing to fit the specific patient being treated.

In any embodiment, the at least one tightening mechanism comprises distal and mesial tightening mechanisms, which are disposed at a distal and a mesial end of the clamp, respectively. However, other embodiments may comprise a single tightening mechanism, which is disposed at a mesial end of the clamp.

In any embodiment, the tooth clamp further comprises a first bridge portion, which connects together the buccal and lingual side portions at either: respective distal ends thereof, or respective mesial ends thereof, wherein the first bridge portion is generally offset from the buccal and lingual side portions in a coronal direction so that, when the clamp is mounted on the plurality of teeth, the first bridge portion passes over the plurality of teeth. In such embodiments, the tooth clamp can, for example, further comprise a second bridge portion, which connects together the buccal and lingual side portions at respective opposite ends of the buccal and lingual side portions to those connected by the first bridge portion, wherein the second bridge portion is generally offset from the buccal and lingual side portions in a coronal direction so that, when the clamp is mounted on the plurality of teeth, the second bridge portion passes over the plurality of teeth. In specific examples, the first bridge portion connects together the buccal and lingual side portions at respective mesial ends thereof, and the second bridge portion connects together the buccal and lingual side portions at respective distal ends thereof, wherein a height of the first bridge portion in the coronal direction is less than a height of the second bridge portion in a coronal direction.

In any embodiment, the plurality of teeth clamped by the tooth clamp consists of 8 or fewer teeth. In specific examples, the plurality of teeth consists of 6 or fewer teeth. In some embodiments, the plurality of teeth consists of 3 or more teeth.

In a further aspect, the present disclosure provides a dental robotic system that comprises: the tooth clamp of any one of the embodiments disclosed herein; a robotic arm, a distal end of which is configured to manipulate an end effector; and a platform, to which a proximal end of the robotic arm is fixed, and to which the tooth clamp is releasably coupled. In some embodiments of the dental robotic system, the coupling of the tooth clamp to the platform maintains the tooth clamp in a fixed position and orientation relative to the platform, and thereby the proximal end of the robotic arm. In some examples, the system further comprises a base and a suspension system, wherein the suspension system: (i) couples the platform to the base, (ii) supports a weight of the platform and the robotic arm, and (iii) permits the position and orientation of the platform to change, relative to the base, in response to forces applied by the plurality of teeth to the tooth clamp, the suspension system thereby accommodating changes in the position and orientation of the plurality of teeth by enabling corresponding changes in the position and orientation of the platform.

In some embodiments, the dental robotic system is configured (e.g., by suitable programming of at least one processor the system) to perform a tooth preparation procedure on the target tooth or target teeth of the plurality of teeth.

In a still further aspect, the present disclosure provides a method of preparing for a robotic dental procedure on a subject, comprising: providing a tooth clamp for mounting on, and rigidly clamping to, a plurality of teeth of the subject, the tooth clamp comprising: a buccal side portion, which is disposed on the buccal side of the plurality of teeth, when the tooth clamp is mounted thereon; a lingual side portion, which is disposed on the lingual side of the plurality of teeth, when the tooth clamp is mounted thereon; at least one tightening mechanism, which allows a user to progressively bring the buccal and lingual side portions closer together, so that the buccal and lingual side portions thereby engage the plurality of teeth with a desired amount of clamping force; and a coupling portion, configured to rigidly couple the clamp to a robotic dental system, wherein an inwardly-facing side of each of the buccal and lingual side portions comprises an impression portion, which is shaped as an impression of the buccal or lingual side, respectively, of the plurality of teeth of the particular subject. The method further comprises: mounting the tooth clamp on the plurality of teeth, so that the buccal and lingual side portions are disposed on, respectively, the buccal and lingual sides of the plurality of teeth; and progressively tightening the tooth clamp, using the at least one tightening mechanism, so that the buccal and lingual side portions thereby engage the plurality of teeth with the desired amount of clamping force.

In some examples, the method further comprises: applying a hardening filler material, in an unhardened state, to at least one of the buccal or lingual side impression portions; contacting the plurality of teeth with the hardening filler material in the unhardened state; and causing the hardening filler material to transition to a hardened state, while the hardening filler material is in contact with the least one of the buccal or lingual side impression portions, and the plurality of teeth. In specific examples, said causing of the hardening filler material to transition to a hardened state is prior to said progressive tightening of the tooth clamp. In some examples, the least one of the buccal and lingual side impression portions comprises both the buccal and the lingual side impression portions. In some examples, the hardening filler material is caused to transition to a hardened state while the hardening filler material is additionally in contact with gingiva of the plurality of teeth. In some examples, the hardening filler material is a dental cement.

In some examples, each of the buccal and lingual side portions comprises a frame portion, and the method comprises: applying a hardening filler material, in an unhardened state, to a buccal space between the buccal side frame portion and the plurality of teeth, and a lingual space between the lingual side frame portion and the plurality of teeth; causing of the hardening filler material to transition to a hardened state, with the hardened filler material in the buccal space providing the buccal side impression portion, and the hardened filler material in the lingual space providing the lingual side impression portion. In specific examples, said causing of the hardening filler material to transition to a hardened state is prior to said progressive tightening of the tooth clamp.

In some examples, the tooth clamp further comprises at least one opening, which exposes, to an exterior of the clamp, at least an occlusal surface of at least one tooth of the plurality of teeth. The at least one exposed tooth may, for example, comprise a target tooth on which a dental procedure will be performed.

In some examples, providing the tooth clamp comprises: receiving a 3D model of the plurality of teeth; and forming at least the buccal and lingual side impression portions based on the three-dimensional model of the plurality of teeth. The forming of the buccal and lingual side impression portions may, for example, utilize at least one additive manufacturing process. The at least one additive manufacturing process can, for instance, comprise 3D printing.

In some examples, the method further comprises coupling the coupling portion to the robotic dental system. In specific examples, the method further comprises, subsequent to said coupling of the coupling portion to the robotic dental system, registering a dental arch of the subject that comprises the plurality of teeth, with a treatment system of the robotic dental system.

In yet another aspect, the present disclosure provides a method for carrying out a robotic dental procedure on a subject, comprising: carrying out the method of preparing for a robotic dental procedure on a subject of any one of the embodiments disclosed herein; coupling the coupling portion to the robotic dental system; and using the robotic dental system to carry out a dental procedure on a target tooth of the subject.

In some examples, the plurality of teeth (onto which the tooth clamp is clamped) comprises the target tooth. However, in other examples, the plurality of teeth may be different from, but part of the same dental arch as the target tooth (or teeth). For example, the plurality of teeth may be located on an opposing side of the dental arch to the target tooth (or teeth).

In some examples, the tooth clamp further comprises at least one opening, which exposes, to an exterior of the clamp, at least an occlusal surface of a target tooth of the plurality of teeth, and wherein, during the dental procedure, the robotic dental system accesses the target tooth via the at least one opening. In specific examples, during the dental procedure, the at least one opening provides the robotic dental system with access to the target tooth.

In some examples, the robotic dental system comprises: a robotic arm, a distal end of which is configured to manipulate an end effector; and a platform, to which a proximal end of the robotic arm is fixed, and to which the tooth clamp is releasably coupled, as a result of said coupling of the coupling portion to the robotic dental system, wherein, as a result of said coupling of the coupling portion to the robotic dental system, the tooth clamp is maintained in a fixed position and orientation relative to the platform, and thereby the proximal end of the robotic arm.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a top view of the exemplary tooth clamp.

FIG. 2 is a perspective view of the tooth clamp of FIG. 1 when clamped in a subject's mouth.

FIG. 3 is a top view of the tooth clamp of FIGS. 1 and 2, when mounted, but not clamped, to a group of the subject's teeth

FIGS. 4A-4D are perspective views of impression portions that form part of the tooth clamp of FIGS. 1-3.

FIG. 5 is an end view of the tooth clamp of FIGS. 1-4D.

FIG. 6 is a further perspective view of the tooth clamp 100 of FIGS. 1-7.

FIG. 7 is a view of a cross-section taken perpendicular to the length of the tooth clamp of FIGS. 1-6.

FIG. 8 is a perspective view of a further example of a tooth clamp.

FIG. 9 is a perspective view of the tooth clamp of FIG. 8 after the application of a hardening filler material.

FIG. 10 is a perspective view of a robotic dental system to which the tooth clamps of FIGS. 1-9 can be coupled.

FIG. 11 is a flow chart that illustrates an example of a method of preparing a plurality of teeth of a subject for a robotic dental procedure.

FIG. 12 is a flow chart that illustrates an example of a method for carrying out a robotic dental procedure on a subject.

### DETAILED DESCRIPTION OF SPECIFIC EMBODIMENTS

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

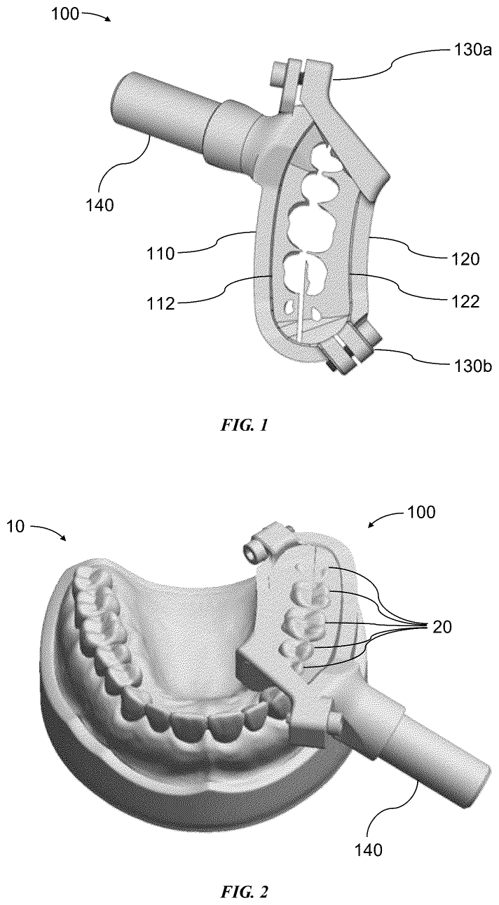

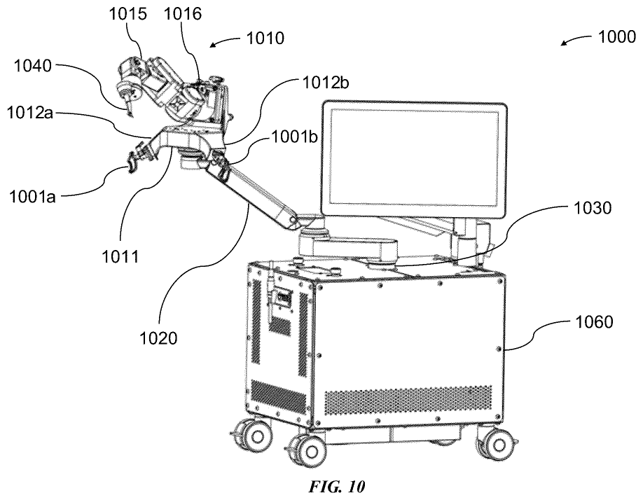

Reference is directed generally to FIGS. 1-7, which illustrate an example of a tooth clamp 100 according to a first aspect of this disclosure. More particularly, reference is directed to FIG. 1, which is a top view of the exemplary tooth clamp 100. As will be discussed in more detail below with reference to FIG. 10, the tooth clamp 100 of FIGS. 1-7 is configured for use in a robotic dental system 1000. To that end, the tooth clamp 100 comprises a coupling portion 140, which is configured to rigidly couple the tooth clamp 100 to such a robotic dental system 1000.

As shown in FIG. 1, tooth clamp 100 comprises a buccal side portion 110 and a lingual side portion 120. As illustrated in FIG. 2, which is a perspective view of the tooth clamp 100 when clamped in a subject's mouth 10, the tooth clamp 100 is configured to securely clamp onto a group of two or more of the subject's teeth 20. By clamping onto multiple (two or more) teeth, the tooth clamp 100 can better resist movement of the tooth clamp 100 relative to the teeth, particularly (but not exclusively) rotational movement about an apical-coronal axis.

Additionally, or alternatively, clamping multiple teeth ensures that the teeth remain in a fixed arrangement relative to one another during treatment. Since each tooth in a subject's mouth is sitting in a periodontal ligament (PDL), each tooth can move when a force as small as a few Newtons is applied. Consequently, the positions and orientations of the teeth neighboring a target tooth (or target teeth) being treated can easily shift during a robotic dental procedure on the target tooth or teeth. Because the tooth clamp 100 of FIGS. 1-7 holds multiple teeth in a fixed relative arrangement, inadvertent contact with or damage to such neighboring teeth during a robotic dental procedure may be avoided.

Additionally, or alternatively, where the tooth clamp 100 is used during a robotic tooth restoration procedure, the tooth clamp 100 can hold neighboring teeth in a suitable position to allow the restoration (e.g., a crown, or a bridge) to be properly placed relative to neighboring teeth. This may avoid the interproximal spaces between the restoration and the neighboring teeth being too large, which can lead to food becoming impacted in the interproximal spaces, even with interproximal spaces of as little as 25 microns, or too small, which may prevent the restoration from being fitted, or cause discomfort to the patient.

As may be apparent from FIG. 2, the tooth clamp 100 of FIGS. 1-7 is configured to securely clamp onto a group of five teeth 20. However, this is of course not essential and in other examples, the tooth clamp 100 could be configured to a group of two, three, four, six, seven, eight, or even more teeth-potentially up to a full arch of teeth. However, it is envisaged that a clamp that clamps onto between two and eight teeth (i.e., up to a half arch of teeth) may suitably balance strength of clamping, on the one hand, and accessibility for the robotic dental system 1000, on the other hand.

It should be appreciated that it is not necessary that the group of teeth 20 consist of a contiguous group of teeth. For example, where a subject has one or more missing teeth (which is a relatively common situation for a subject requiring a tooth restoration) the tooth clamp 100 may clamp onto the remaining teeth adjacent the missing teeth.

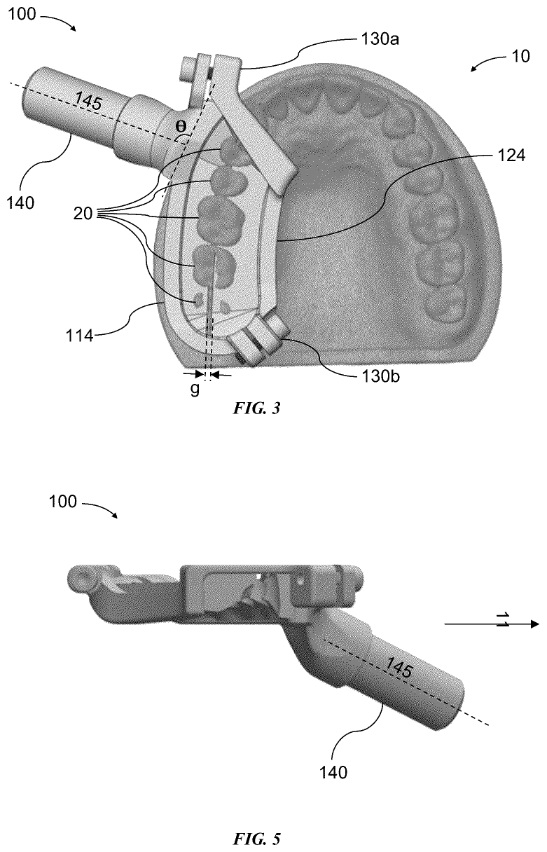

As part of the clamping procedure, the tooth clamp 100 is initially mounted on (but not clamped to) the group of teeth 20, so that the buccal side portion 110 is disposed on the buccal side of the group of teeth 20, and so that the lingual side portion 120 is disposed on the lingual side of the group of teeth 20. FIG. 3 shows the tooth clamp 100 thus-mounted on the group of teeth 20. Because the tooth clamp 100 is mounted, but not yet clamped to the group of teeth 20, a gap, g, is visible in FIG. 3 between the buccal and lingual side portions 110, 120. Once the tooth clamp 100 has been suitably mounted on the group of teeth 20, an operator of the tooth clamp 100 (e.g., a dentist or a dental technician) uses tightening mechanisms 130a, 130b on the tooth clamp 100 to bring the buccal and lingual side portions 110, 120 closer together, to thereby engage the group of teeth 20 with a desired amount of clamping force.

In the particular example shown in FIGS. 1-7, the tooth clamp 100 comprises two tightening mechanisms 130a, 130b, each of which comprises a screw and a correspondingly-threaded hole. However, this is by no means essential and, in other examples, the tooth clamp 100 could include any suitable number of tightening mechanisms 130a, 130b (e.g., one, two, three, four, or more) and/or could include tightening mechanisms 130a, 130b with any suitable structure (e.g., a cam, a gear, a ratchet, a spring, one or more magnets, or any combination thereof).

As may be appreciated, the two tightening mechanisms 130a, 130b of the tooth clamp 100 of FIGS. 1-7 pull together the buccal and lingual side portions 110, 120 at opposite ends of the tooth clamp 100. In general, pulling the together the buccal and lingual side portions 110, 120 at two or more locations spaced apart along the length of the tooth clamp 100 can distribute compressive forces more evenly along the length of the tooth clamp 100.

As may also be appreciated, the two tightening mechanisms 130a, 130b of the tooth clamp 100 of FIGS. 1-7 operate independently to pull together the buccal and lingual side portions 110, 120. However, this is by no means essential and, in other examples, a single tightening mechanism could simultaneously apply force to pull together both the buccal and lingual side portions 110, 120 at two or more locations spaced apart along the length of the tooth clamp 100. For example, such a tightening mechanism could comprise a dial or knob that shortens a wire loop that connects together the buccal side portion 110 to the lingual side portion 120 at two or more locations along the length of the tooth clamp 100. In still further examples, the tooth clamp 100 could comprise multiple such tightening mechanisms.

In general, the tightening mechanisms 130a, 130b of the tooth clamp 100 may be configured to maintain the clamping force until further action is taken by the operator to loosen the tooth clamp 100, e.g., using the tightening mechanisms 130a, 130b. The further action may, for example, be the opposite of the action required to tighten the tooth clamp 100. For instance, clockwise rotation of a screw (as in the example shown in FIGS. 1-7), a knob, a dial, or the like, may tighten the tooth clamp 100, whereas counterclockwise rotation of such elements may loosen the tooth clamp 100, as is the case in the tooth clamp 100 of FIGS. 1-7. In addition, or instead, the tightening mechanisms 130a, 130b might provide a quick release functionality, for example in response to a different action by the operator, such as pulling a quick release catch.

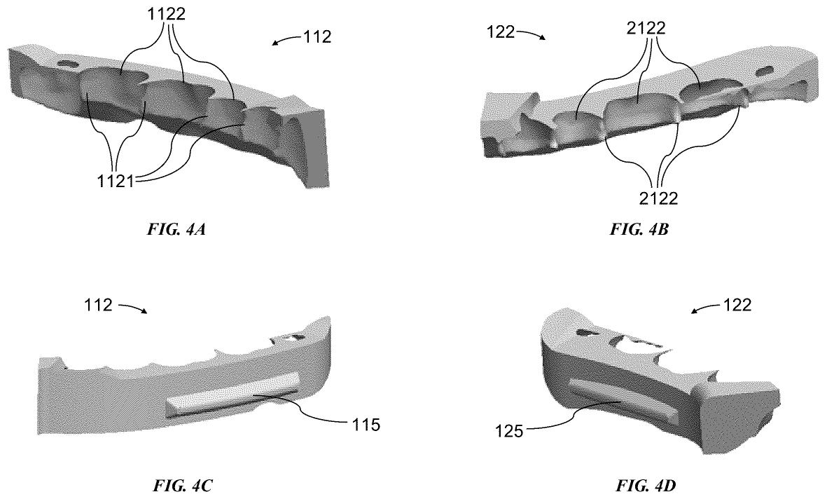

Reference is now directed to FIGS. 4A and 4B, which are perspective views of two impression portions 112, 122 that form a part of the buccal and lingual side portions 110, 120 respectively. While the impression portions 112, 122 are also visible in FIGS. 1-3, the shapes of the surfaces of the impression portions 112, 122 that face towards the group of teeth 20 are particularly visible in FIGS. 4A and 4B. As may be seen from FIGS. 4A and 4B, the buccal side impression portion 112 is shaped as an impression of the buccal side of the group of teeth 20 that are/will be clamped by the tooth clamp 100, whereas the lingual side impression portion 122 is shaped as an impression of the lingual side of the group of teeth 20 that are/will be clamped by the tooth clamp 100. Put differently, the surface geometry of the part of the buccal side impression portion 112 facing the group of teeth 20 is complementary to of the surface geometry of the group of teeth 20 and the surface geometry of the part of the lingual side impression portion 122 facing the group of teeth 20 is complementary to the surface geometry of the lingual side of the group of teeth 20. Such shaping of the impression portions 112, 122 assists the tooth clamp 100 in securely clamping to the group of teeth 20.

As further shown in FIGS. 4A and 4B, the impression portions 112, 122 each comprise a plurality of protrusions 1121, 1221 corresponding to the interproximal spaces of the group of teeth 20, and comprise a plurality of invaginations 1122, 1222 corresponding to the buccal/lingual side surfaces of the group of teeth 20. Again, such shaping of the impression portions 112, 122 may assist the tooth clamp 100 in securely clamping to the group of teeth 20.

It will be appreciated from FIGS. 4A and 4B that the impression portions 112, 122 are inherently shaped as impressions of the group of teeth 20, i.e., they have such a shape in an undeformed state, prior to contact with the group of teeth 20. This may be contrasted with, for example, tooth clamps with tooth-engaging parts made from an easily deformable material, such as rubber or foam, that only assumes the shape of the teeth when pressed against them.

In general, impression portions 112, 122 may be formed using any suitable technique, such as additive or subtractive manufacturing techniques, moulding techniques, etc. However, it is anticipated that additive manufacturing techniques, such as 3D printing, may provide a suitable balance of accuracy and speed of formation. This may, for example, enable custom (patient specific) impression portions 112, 122 to be manufactured as part of a single visit to a dental facility by a patient. For instance, the teeth of the patient may be scanned or imaged at the beginning of the visit to the facility and custom impression portions 112, 122 may be made at the facility, e.g. using a 3D printer, shortly thereafter.

Moreover, in some cases, the custom impression portions 112, 122 may be made using the same device(s) as is/are used to make a custom indirect restoration (e.g., crown, bridge, inlay, onlay etc.) for the patient. However, the impression portions 112, 122 may, in some cases, be made from different materials to the indirect restoration. For instance, the impression portions 112, 122 may be made from materials that are relatively less robust, relatively less hard, and/or relatively less expensive as compared with the materials used to make the indirect restoration, given that the impression portions 112, 122 will be used for only a number of minutes or hours, whereas the indirect restoration will need to withstand years of use.

In some cases, care may need to be taken to form the impression portions 112, 122 without undercuts that would block the impression portions 112, 122 from being pushed onto the sides of the group of teeth 20. Where the impression portions 112, 122 are formed using additive manufacturing, this may, for example, be accomplished by suitable processing of the data defining the 3D shape of the impression portions 112, 122 and/or could be accomplished by machining the impression portions 112, 122 to remove such undercuts.

Reference is now directed once more to FIG. 2, which (as noted above) shows the tooth clamp 100 when clamped on the group of teeth 20, i.e. following use of the tightening mechanisms 130a, 130b to apply a suitable clamping force to the group of teeth 20. As may be seen from FIG. 2, an apical side of each of the impression portions 112, 122 is exposed to an exterior of the the tooth clamp 100. This can, for example, facilitate access to and/or sensing of the group of teeth 20.

As may also be seen from FIG. 2, in the clamped state, the tooth clamp 100 includes a series of openings 150a-e, which expose the occlusal surfaces of the group of teeth 20 to an exterior of the clamp. In the particular example shown, the openings 150a-e are provided jointly by the impression portions 112, 122. The openings 150a-e assist a robotic dental system 1000, to which the tooth clamp 100 is coupled, in accessing a target tooth 25 (or target teeth) that will be treated by the robotic dental system 1000. Additionally (or alternatively, the openings 150a-e assist the robotic dental system 1000 in positioning and orienting its end effector (such as a dental burr, a laser, etc.) relative to the target tooth 25 (or target teeth), for example by using the occlusal surfaces of the group of teeth 20 (and/or any other surfaces exposed by the openings 150a-e) to provide a series of landmarks or fiducials for the group of teeth 20, for example during a registration process for the robotic dental system 1000.

Such a registration process may, for instance, involve using one or more spatial measurement devices to determine a spatial relationship between the patient's teeth and a treatment system of the robotic dental system 1000 (such as the treatment system 1010 described below with reference to FIG. 10). The treatment system 1010 is the part of the robotic dental system 1000 that directly interacts with the patient to carry out a dental procedure. Accordingly, during the dental procedure, the movement and/or operation of the treatment system 1010 is controlled by suitably programmed processor(s) of the the robotic dental system 1000, for example based on a predefined treatment plan that has been approved by a dentist. In some examples, such as that described below with reference to FIG. 10, the treatment system 1010 may include a robotic arm (such as robotic arm 1015, described below). In particular examples, the spatial relationship between the patient's teeth and an end effector of the treatment system (or a part thereof, such as the burr tip, in the case where the end effector comprises a dental burr) may be determined.

The registration process may be viewed as determining a transformation between a coordinate system for the patient's teeth and a coordinate system for the operation of the treatment system 1010. Such a coordinate transformation enables the robotic dental system 1000 to determine which part of the patient's dental anatomy the treatment system 1010 is operating on, as the treatment system 1010 (or its components) move relative to the dental anatomy.

Suitable spatial measurement devices can include, for example, intraoral scanners (which may, for example, use structured light, as is the case in many commercially available intraoral scanners, and/or which may use optical coherence tomography, as described in, for example, commonly owned PCT application WO2024054937A1), confocal microscopes, laser rangefinders, and/or 2D or 3D cameras (which may, for instance, use photogrammetry techniques to identify visual features and the spatial relationships between them).

Although the tooth clamp 100 of FIGS. 1 and 2 includes openings 150a-e that expose the occlusal surfaces of the group of teeth 20 to an exterior of the clamp, it should be appreciated that this is not essential. In other examples, instead of (or in addition to) providing openings, the impression portions 112, 122 could be formed from transparent material, so that the features/landmarks of the group of teeth 20 can still be identified by the spatial measurement device(s). The material can, for example, be selected based on the particular spatial measurement device(s) utilised for registration. For instance, the selected material may be transparent to, for example, visible light (for instance, where a conventional intraoral scanner is used), infrared (for instance, where an OCT intraoral scanner is used), and/or ultraviolet.

Additionally, although the openings 150a-e are described above as providing access to a target tooth 25 (or target teeth), it should be noted that it is by no means essential that the target tooth 25 (or target teeth) is/are among the group of teeth 20 that are held by the tooth clamp 100. Accordingly, in other examples, the target tooth 25 (or target teeth) can, for instance, be disposed on the opposite side of the same arch as the group of teeth 20 held by the tooth clamp 100. In such cases, registration may be carried out using teeth other than the group of teeth 20 held by the tooth clamp 100; for instance, registration can be carried out using the target tooth 25 (or target teeth) or neighbouring teeth in the same arch. Hence (or otherwise), the tooth clamp 100 may in some examples not include openings 150a-e that expose occlusal surfaces of the group of teeth 20 held by the tooth clamp 100.

Furthermore, because the tooth clamp 100 firmly maintains the group of teeth 20 in a fixed relative arrangement (i.e., their relative positions and orientations remain the same), the robotic dental system 1000 can rely on the group of teeth 20 for positioning and orienting its end effector for as long as the tooth clamp 100 remains clamped on the group of teeth 20; thus it may not be necessary to repeat the process for registering the robotic dental system 1000 relative to the target tooth 25 (or target teeth), simplifying operation of the robotic dental system 1000.

Referring once again to FIG. 3, it may be noted that, in the particular example shown, the coupling portion 140 extends from an outward-facing surface 114 of the buccal side portion 110. Such an arrangement may assist an operator of the tooth clamp 100 in easily coupling the coupling portion 140 to the robotic dental system 1000. It is, however, by no means essential that the coupling portion 140 extends from the outward-facing surface 114 of the buccal side portion 110 and, in other examples, the coupling portion 140 could, for instance, extend from an outward-facing surface 124 of the lingual side portion 120 instead. (By “outward-facing”, it is meant that outward-facing surface 124 of the lingual side portion 120 faces outwardly from the tooth clamp 100, not that it faces outwardly from the subject's mouth 10.)

It may further be noted that, in the particular example shown, the coupling portion 140 is elongate in a length direction 145 that meets the outward-facing surface 114 of the buccal side portion 110 at an oblique angle (θ). Such an arrangement (or even one where the length direction 145 that meets the outward-facing surface 114 at a right angle) may similarly assist an operator of the tooth clamp 100 in easily coupling the coupling portion 140 to the robotic dental system 1000, for example by making the coupling portion 140 more accessible.

Reference is directed next to FIG. 5, which is an end view of the tooth clamp 100. As may be seen from FIG. 5, in the particular example shown, the length direction 145 of the coupling portion 140 has a component directed towards the apical direction 11 (i.e., towards the roots of the teeth). Such an arrangement of the coupling portion 140 may improve access to the group of teeth 20 for the robotic dental system 1000.

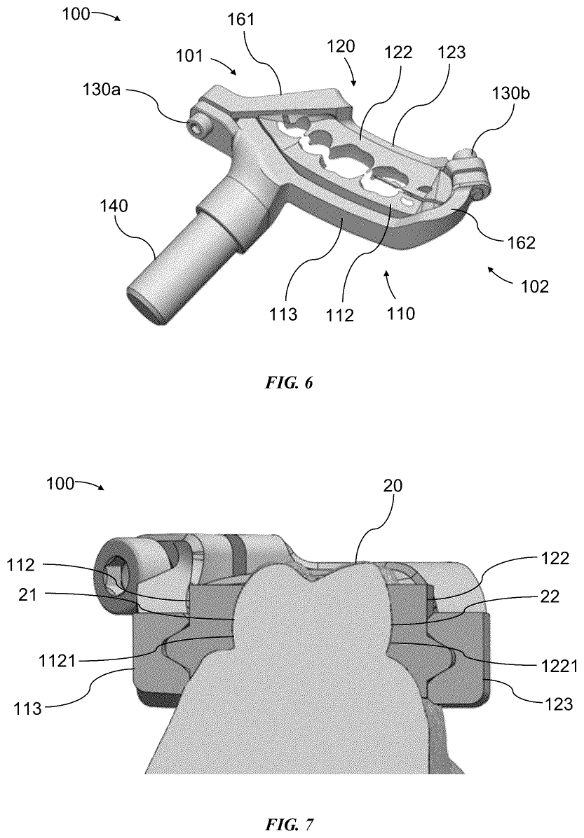

Reference is now directed to FIG. 6, which is a further perspective view of the tooth clamp 100 of FIGS. 1-7. As indicated in FIG. 6, in the particular example shown, each of the buccal and lingual side portions 110, 120 comprises a respective frame portion 113, 123, each of which holds the corresponding one of the impression portions 112, 122. To that end, the impression portions 112, 122 and frame portions 113, 123 may comprise complementarily-shaped engagement features that assist them in attaching to each other (though this is of course not essential). Exemplary engagement features 115, 125 for the impression portions 112, 122 are shown in FIGS. 4C and 4D, which are perspective views of the rear sides of the impression portions 112, 122. In general, the frame portions 113, 123 may, for example, be described as providing an enclosing and/or supporting structure for the impression portions 112, 122.

As may also be seen from FIG. 6, in the particular example shown, the frame portions 113, 123 provide the tightening mechanisms 130a, 130b of the tooth clamp 100. This may be particularly (but not exclusively) effective where the frame portions 113, 123 are formed from a resilient material, such as a metallic material (a metal or alloy, such as stainless steel). However, it is by no means essential the frame portions 113, 123 provide the tightening mechanisms 130a, 130b of the tooth clamp 100, and, in other examples, the tightening mechanisms 130a, 130b could, for example be provided instead (or in addition) by the impression portions 112, 122.

In general, the frame portions 113, 123 may be formed from different materials to the impression portions 112, 122 (though this is by no means essential). The frame portions 113, 123 may, for example, be formed from a resilient material, such as a metallic material (a metal or alloy, such as stainless steel), so as to assist in providing structural support for the impression portions 112, 122 and/or to assist in transmitting and/or maintaining compression forces on the impression portions 112, 122 and thereby the group of teeth 20. In still other examples, the frame portions 113, 123 may be formed from stiff polymers (such as PEEK, glass or carbon filled PEEK, Ultem, Polysulfone, or PAI), ceramics, and/or composite materials. In general, the material of the frame portions 113, 123 may have a high Young's modulus, in order to resist compressive forces, such as at least 50, at least 100, or at least 150.

The impression portions 112, 122 may, for example, be formed of polymeric materials, for instance to enable them to be easily and/or accurately formed with complementary shapes to the shapes of the group of teeth 20. In a specific example, the impression portions 112, 122 may be formed substantially of photocurable resin. This may particularly (but not exclusively) be the case where the impression portions 112, 122 are formed by 3D printing. In general, although the material of the impression portions 112, 122 need not be as resistant to compressive forces as the frame portions 113, 123, the material should still be sufficiently resistant that it does not substantially change shape during use. Accordingly, the material of the impression portions 112, 122 may have a Young's modulus of at least 0.5, at least 0.75, or at least 1.0.

More generally, it is envisaged that, in some examples, the materials used to construct the tooth clamp 100 may allow for sterilization (e.g., high-pressure steam (autoclave), dry heat (oven), chemical sterilants (ethylene oxide, glutaraldehydes and/or formaldehyde solutions) or physical agents (radiation)). Hence, or otherwise, the tooth clamp 100 may be re-used for multiple procedures.

It should also be appreciated that it is by no means essential that the tooth clamp 100 comprises frame portions 113, 123. Accordingly, in other examples, impression portions 112, 122 may themselves provide the support structure of the tooth clamp 100 and/or may provide the tightening mechanisms 130a, 130b of the tooth clamp 100.

Referring once more to FIG. 6, it may be noted that, in the particular example shown, the tooth clamp 100 comprises first and second bridge portions 161, 162, which connect together the buccal and lingual side portions 110, 120 (and, more particularly, the buccal and lingual side frame portions 113, 123) at, respectively, the mesial and distal end 101, 102 of the tooth clamp 100. As may be apparent from FIG. 6, the first bridge portion 161 is generally offset from the buccal and lingual side portions 110, 120 in a coronal direction so that, when the clamp is mounted on the group of teeth 20, the first bridge portion 161 passes over the group of teeth 20. The second bridge portion 162 is likewise generally offset from the buccal and lingual side portions in a coronal direction so that, when the clamp is mounted on the plurality of teeth, the second bridge portion 162 passes over the group of teeth 20. As may also be apparent from FIG. 6, the height (i.e., the extent, or profile) in the coronal direction of the first bridge portion 161 (which is located at the mesial end 101) is less than a height (extent/profile) of the second bridge portion 162 (which is located at the distal end 102). Such an arrangement may make the group of teeth 20 easily accessible to the robotic dental system 1000, which will typically approach the group of teeth 20 from the front of the subject's mouth.

Reference is now made to FIG. 7, which is a view of a cross-section taken perpendicular to the length of the tooth clamp 100 of FIGS. 1-7, when the tooth clamp 100 is clamped on the group of teeth 20. Further features of the impression portions 112, 122 are visible from FIG. 7. Specifically, in the particular example shown, a part 1121, 1221 of each of the impression portions 112, 122 is shaped as an impression of surfaces of the plurality of teeth that are disposed on a gingival side (i.e., towards the gums) of a height of contour 21, 22 of the plurality of teeth (where height of contour refers to the part of a tooth at which it has its greatest lateral extent). In general, having parts of each of the impression portions 112, 122 shaped as an impression of surfaces of the plurality of teeth that are disposed on a gingival side of a height of contour 21, 22 of the plurality of teeth may enable the tooth clamp 100 to clamp onto the group of teeth 20 particularly securely. It may be noted that, in the example shown in FIG. 7, parts of each of the impression portions 112, 122 are also shaped as impressions of surfaces of the plurality of teeth that are disposed on a coronal side (i.e., towards the crown) of a height of contour 21, 22 of the plurality of teeth. Having this additional engagement may further secure the tooth clamp 100 to the group of teeth 20.

In some examples, one or more parts of the impression portions 112, 122 may be shaped as an impression of at least the majority of the surfaces of the plurality of teeth that are disposed on a gingival side of a height of contour 21, 22 of the plurality of teeth. This may provide a still more secure engagement with the group of teeth 20. Indeed, in further examples, one or more parts of the impression portions 112, 122 are shaped as an impression of 75%, or substantially all of the surfaces of the plurality of teeth that are disposed on a gingival side of a height of contour 21, 22 of the plurality of teeth.

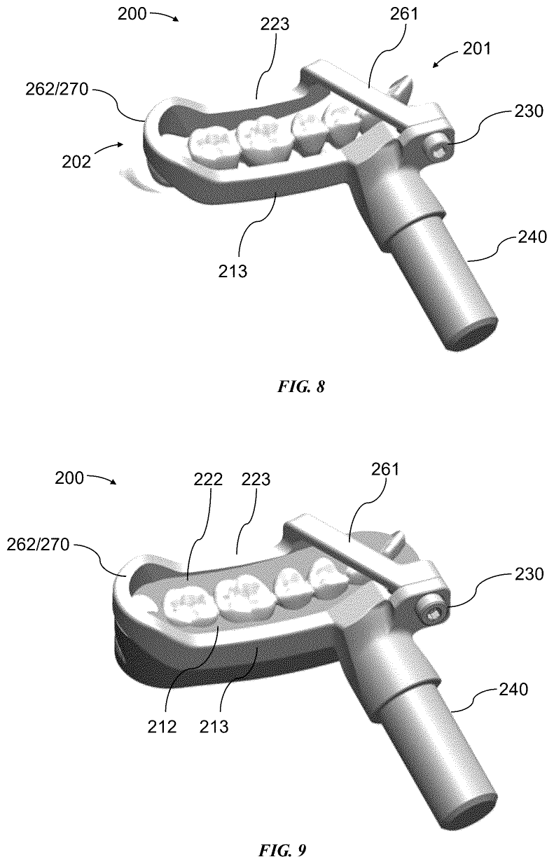

Reference is now directed to FIGS. 8-9, which illustrate a further example of a tooth clamp 200 according to the same aspect as the tooth clamp 100 of FIGS. 1-7.

It may be noted that, in contrast to the tooth clamp 100 of FIGS. 1-7, the tooth clamp 200 of FIGS. 8-9 includes only a single tightening mechanism 230, which is disposed at the mesial end 201 of the tooth clamp 200. However, like the tooth clamp 100 of FIGS. 1-7, the tooth clamp 200 of FIGS. 8-9 comprises first and second bridge portions 261, 262, which are disposed at the mesial and distal ends 201, 202 of the tooth clamp 200, respectively.

As shown in FIG. 8, the tooth clamp 200 of FIGS. 8-9 comprises a biasing portion 270, which urges the buccal and lingual side portions 210, 220 away from each other, towards an open configuration of the tooth clamp 200. In the particular example shown, an arcuate frame end 262/270 portion acts as both biasing portion 270 and bridge portion 262. Furthermore, it may be noted that the arcuate frame end 262/270 portion is integrally formed with the respective mesial ends of the buccal and lingual side portions 210, 220 (and, more specifically, is integrally formed with the mesial ends of the buccal and lingual side frame portions 213, 223). However, while this is a convenient solution, it is by no means essential and, in other examples, the biasing portion 270 could simply be provided by a spring extending between the buccal and lingual side portions 210, 220.

In the open configuration, the buccal and lingual side portions 210, 220 are spaced apart by a spacing that is greater than that at which the tightening mechanism 230 can operate. This enables the buccal and lingual side portions 210, 220 to provide a wide opening to receive the group of teeth 20. The buccal and lingual side portions 210, 220 can be squeezed together manually, or with a tool, to adopt a “gapped” configuration, at which point the tightening mechanism 230 is operable.

In the “gapped” configuration, a hardening filler material, such as a dental cement, may be introduced into the space(s) between the buccal and lingual side frame portions 213, 223 and the group of teeth 20. The filler material is then caused to harden, thus providing buccal and distal side impression portions 212, 222. In effect, the completed tooth clamp 200, including the buccal and distal side impression portions 212, 222, is provided in-situ, within the subject's mouth. As may be appreciated, in some cases, the hardening filler material may flow around the group of teeth 20 sufficiently for the buccal and distal side impression portions 212, 222 to be formed integrally with one another. Hence (or otherwise), the hardening filler material may be selected so as to be flowable in its unhardened state.

While in the tooth clamps 100, 200 of FIGS. 1-9 the bridge portions 161, 162, 261, 262 are configured to pass over the group of teeth 20, it should be understood that this is not essential. For example, where the tooth clamp is intended for use in a subject having one or more missing teeth, one or more bridge portions could be configured to pass through the gaps corresponding to the missing teeth. As another example, a distal bridge portion could be configured to pass distally around the final molar in a subject's mouth.

Reference is now directed to FIG. 10, which is a perspective view of an example of a robotic dental system 1000 to which two clamps 1001a, 1001b (each of which may be either a tooth clamp 100 as described with reference to FIGS. 1-9 or a tooth clamp 200 as described with reference to FIGS. 8-9) have been coupled. As shown, the two clamps 1001a, 1001b are configured as mirror images of one another, so that an operator of the system can easily select an appropriately-shaped clamp depending on, for example, which side of the subject's mouth will be treated. It will, however, be understood that this is by no means essential and that only one clamp could be coupled to the robotic dental system 1000. Moreover, in other examples, the robotic dental system 1000 could be configured such that only one clamp may be coupled thereto (or could even be configured so that three or more clamps could be coupled thereto). In general, the robotic dental system 1000 may be any of the systems described in U.S. application Ser. No. 18/656,502, the entire contents of which are hereby incorporated by reference herein, for all purposes. clamps 1001a, 1001b

As may be seen from FIG. 10, the robotic dental system 1000 comprises a robotic arm 1015, a distal end of which is configured to manipulate an end effector 1040, and a platform 1011, to which a proximal end 1016 of the robotic arm 1015 is fixed, and to which the tooth clamps 1001a, 1001b are releasably coupled (by way of respective coupling portions 1012a, 1012b, as shown). The platform 1011 provides a rigid mechanical connection between the clamps 1001a, 1001b and the proximal end 1016 of the robotic arm 1015, so that the proximal end 1016 of the robotic arm 1015 remains in a fixed position and orientation relative to each of the clamps 1001a, 1001b. Hence, the proximal end 1016 of the robotic arm 1015 remains in a fixed position and orientation relative to the teeth clamped by whichever one of the clamps 1001a, 1001b is currently in use.

As may also be seen from FIG. 10, the robotic dental system 1000 further comprises a base 1030, and a suspension system 1020, which mechanically couples the platform 1011 with the base 1030. The base 1030 of the robotic dental system 1000 remains generally stationary during a procedure and hence remains in a generally fixed position and orientation with respect to the environment in which the robotic dental system 1000 is operating (e.g., a room or space in a dental practice where the procedure is being carried out). In the particular example shown, the base 1030 is fixed to a cart 1060, which rests on the floor, but this is of course not essential and the base 1030 could instead simply be fixed to the floor.

As indicated in FIG. 10, the platform 1011 and the robotic arm 1015 are part of a treatment system 1010 of the robotic dental system 1000. The treatment system 1010 is able (with the aid of a suspension system 1020 of the robotic dental system 1000) to accommodate movement by the subject during treatment, thereby promoting the comfort of the subject during treatment, while maintaining the accuracy of the robotic arm 1015.

In the particular example shown in FIG. 10, the suspension system 1020 comprises a series of linkages connected by joints. Hence (or otherwise), the suspension system 1020 permits the position and orientation of the platform 1011 to change, relative to the base 1030, in response to forces applied by the clamped group of teeth 20 to the tooth clamp 100, thereby accommodating changes in the position and orientation of the clamped group of teeth 20 by enabling corresponding changes in the position and orientation of the platform 1011. It will however be appreciated that the particular structure shown in FIG. 10 is by no means essential and in other examples the suspension system 1020 may have any suitable structure that permits the position and orientation of the platform 1011 to change, relative to the base 1030, in response to forces applied by the clamped group of teeth 20 to the tooth clamp 100, thereby accommodating changes in the position and orientation of the clamped group of teeth 20 by enabling corresponding changes in the position and orientation of the platform 1011. For example, suitable structures might comprise spring-loaded linkages, gimbals, linkages connected by friction joints and the like. Moreover, the suspension system 1020 is not limited to a linear structure. Accordingly, in other examples, the suspension system could, for instance, include linkages in more complex arrangements, such as, for example, a four-bar linkage arrangement.

It should be appreciated that the suspension system 1020 supports the weight of the treatment system 1010, including the platform 1011 and the robotic arm 1015, so that they feel nearly weightless to the subject. Consequently, the platform 1011 can “float” with respect to the floor (or the ground). Hence (or otherwise), a relatively large and/or complex robotic arm 1015 may be utilized in the robotic dental system 1000.

It should further be appreciated that the suspension system 1020 can be configured as a passive (unpowered) system, or an active (powered) system (in which case the suspension system 1020 moves in response to input from, for example, sensors provided on or adjacent tooth clamp 100.)

It will be appreciated that the robotic dental system 1000 may additionally comprise a control system (not shown) that comprises at least one processor. The control system governs the operation of various subsystems within the robotic dental system 1000 (e.g., as a result of suitable programming of the at least one processor). However, in other examples, the robotic dental system 1000 may be configured such that it can be provided to an end-user without an integrated control system. In such cases the end user might, for example, use their own general purpose computer (such as a laptop computer) as a control system for the robotic dental system 1000, for instance after downloading and installing suitable software on the general purpose computer.

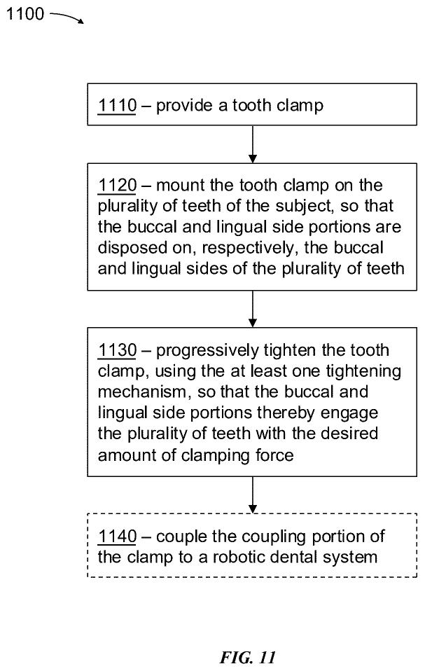

Reference is now directed to FIG. 11, which is a flow chart that illustrates an example of a method 1100 of preparing a plurality of teeth of a subject for a robotic dental procedure according to a further aspect of this disclosure.

As shown, the method 1100 comprises a step 1110 of providing a tooth clamp for mounting on, and rigidly clamping to, the plurality of teeth of the subject. The tooth clamp provided in step 1110 may be a tooth clamp according to any of the examples disclosed herein, such as those described above with reference to FIGS. 1-7 and FIGS. 8-9. Hence, or otherwise, the tooth clamp provided in step 1110 comprises: a buccal side portion, which is disposed on the buccal side of the plurality of teeth, when the tooth clamp is mounted thereon; a lingual side portion, which is disposed on the lingual side of the plurality of teeth, when the tooth clamp is mounted thereon; at least one tightening mechanism, which allows a user to progressively bring the buccal and lingual side portions closer together, so that the buccal and lingual side portions thereby engage the plurality of teeth with a desired amount of clamping force; a coupling portion, configured to rigidly couple the clamp to a robotic dental system; and at least one opening, which exposes, to an exterior of the clamp, at least an occlusal surface of a target tooth of the plurality of teeth. An inwardly-facing side of each of the buccal and lingual side portions comprises an impression portion, which is shaped as an impression of the buccal or lingual side, respectively, of the plurality of teeth of the particular subject.

As further shown in FIG. 11, method 1100 further comprises a step 1120 of mounting the tooth clamp on the plurality of teeth of the subject, so that the buccal and lingual side portions are disposed on, respectively, the buccal and lingual sides of the plurality of teeth.

As also shown in FIG. 11, method 1100 additionally comprises a step 1130 of progressively tightening the tooth clamp, using the at least one tightening mechanism, so that the buccal and lingual side portions thereby engage the plurality of teeth with the desired amount of clamping force. As will be appreciated, the clamping is non-invasive, in the sense that the skin (e.g., of the gums) is not broken during the clamping and thus presents a minimal level of risk to the subject or patient.

In some examples, method 1100 further comprises applying a hardening filler material, in an unhardened state, to at least one of the buccal or lingual side impression portions of the tooth clamp. Such a filler material can, for example, account for inaccuracies in the formation of the impression portions and/or can fill spaces, such as undercut spaces, that the buccal and/or lingual side impression portions inherently cannot reach. Such examples further comprise the steps of: contacting the plurality of teeth (and, optionally, the gingiva of the plurality of teeth) with the hardening filler material in the unhardened state; and causing the hardening filler material to transition to a hardened state, while the hardening filler material is in contact with the least one of the buccal or lingual side impression portions, and the plurality of teeth.

Any filler material that is hardenable and biocompatible may be utilized. For instance, the filler material may be a dental cement, such as dental provisional material. The hardening may, for example, simply be caused by leaving the filler material in place for a sufficient amount of time; however, it could instead be caused by the application of UV light (i.e., the filler material may be UV-curable). To assist with application (or otherwise), the filler material may be flowable in its unhardened state.

In some such examples, the hardening filler material may be (pre) applied, in the unhardened state, to the impression portions of the tooth clamp and/or the plurality of teeth, prior to step 1120 of mounting the tooth clamp on the plurality of teeth of the subject. In other such examples, the hardening filler material may be applied, in the unhardened state, to the impression portions of the tooth clamp and the plurality of teeth, after step 1120 of mounting the tooth clamp on the plurality of teeth of the subject. In such cases, the tooth clamp may, for example, be configured with channels or conduits that can convey the unhardened filler material to the spaces between the tooth clamp and the plurality of teeth.

In some such examples, the hardening filler material may be caused to transition to a hardened state prior to step 1130 of progressively tightening the tooth clamp. However, this is not essential and, in other examples, the hardening filler material may, for instance, be caused to transition to a hardened state during step 1130 of progressively tightening the tooth clamp.

In some examples, step 1110 of providing the tooth clamp comprises: receiving a 3D model of the plurality of teeth; and forming at least the buccal and lingual side impression portions based on the three-dimensional model of the plurality of teeth. Such forming of the buccal and lingual side impression portions based on a 3D model may, for example, utilize at least one additive manufacturing process, such as 3D printing. However, other examples might conceivably utilize subtractive manufacturing processes, such as computer-controlled milling processes.

As will be appreciated, the 3D model of the plurality of teeth can be generated using any suitable technique, such as scanning using a conventional intraoral scanner, scanning using an optical coherence tomography (OCT) scanner, scanning and/or imaging using X-rays, or any combination thereof. In some examples, generating the 3D model of the plurality of teeth by scanning and/or imaging the plurality of teeth, is a further step of method 1100. Generating the 3D model as part of the method 1200 may provide a particularly up-to-date 3D model, thereby assisting the impression portions 112, 122 in fitting accurately against the group of teeth 20. In some cases, the scanning may occur during the same visit to a dental office as the clamping of the tooth clamp, thus making the treatment process more convenient for the patient.

In examples where the forming of the buccal and lingual side impression portions is based on a 3D model of the subject's teeth, the impression portions can, for example, be designed (e.g., with the aid of suitable 3D modeling software) such that, when the clamp is clamped on the plurality of teeth, the plurality of teeth and the clamp are in a desired arrangement and/or the teeth are in a desired arrangement relative to one another. For example, the desired arrangement: may result in the teeth being generally aligned with a longitudinal or central axis of the clamp; may result in the clamp holding the teeth particularly securely, even when some teeth are missing; may place in the clamp in a location within the mouth that provides improved access to the dental robotic system during a procedure; and/or may simplify the insertion of a dental restoration.

As further shown in FIG. 11, the method 1100 may optionally comprise an additional step 1140 of coupling the coupling portion of the clamp to a robotic dental system. The coupling may, in some examples, be a rigid coupling, so that the position and orientation of the clamp remains fixed relative to, for example, a treatment system of the robotic dental system. This can, for example, avoid the need to re-register the clamp and/or dental anatomy relative to the treatment system.

Moreover, in some examples, the method 1100 may comprise, subsequent to step 1140 of coupling of the coupling portion to the robotic dental system, a step of registering the dental arch of the subject held by the clamp, with a treatment system of the robotic dental system. As may be appreciated, such registering may comprise: using one or more spatial measurement devices (for example, as described above in connection with the tooth clamp 100 of FIGS. 1-7) to determine a spatial relationship between the plurality of teeth and a treatment system of the robotic dental system; and determining, based on the thus-determined spatial relationship, a transformation between a coordinate system for the plurality of teeth and a coordinate system for the treatment system.

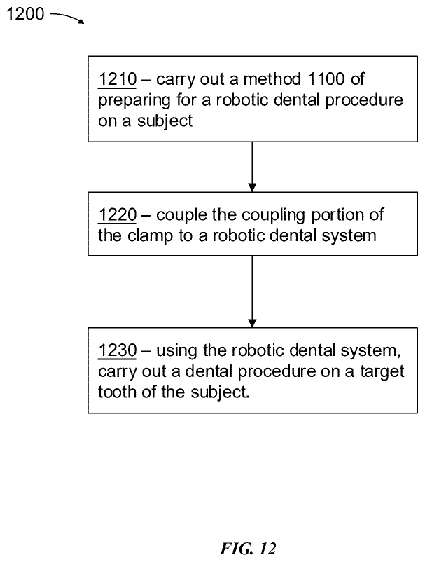

Reference is now directed to FIG. 12, which is a flow chart that illustrates an example of a method 1200 for carrying out a robotic dental procedure on a subject, according to a still further aspect of this disclosure.

As shown, the method 1200 comprises a step 1210 of carrying out a method 1100 of preparing a plurality of teeth of a subject for a robotic dental procedure according to any of the examples described herein, in particular those described above with reference to FIG. 11. This results in a tooth clamp being securely clamped to a group of teeth of the subject.

As FIG. 12 also shows, the method 1200 further comprises a step 1220 of coupling (e.g., rigidly and/or releasably coupling) the coupling portion of the clamp to a robotic dental system. Although step 1220 is depicted in FIG. 12 as being subsequent to step 1210, it should be understood that the order of these steps can be reversed, such that the tooth clamp is coupled to the robotic dental system prior to the tooth clamp being clamped onto the teeth of the subject.

As further shown by FIG. 12, the method 1200 additionally comprises a step 1230 of using the robotic dental system to carry out a dental procedure on the target tooth. As noted above in connection with FIG. 11, the tooth clamp provided during step 1110 of method 1100 may, in some examples, comprise at least one opening that exposes, to an exterior of the clamp, at least an occlusal surface of a target tooth. In certain such examples, during the robotic dental procedure of step 1230, the robotic dental system may conveniently access the target tooth via the at least one opening.

In some examples, the at least one opening exposes, to an exterior of the clamp, occlusal surfaces of the target tooth and one or more other teeth in the group held by the clamp. The one or more exposed teeth may be immediately adjacent the target tooth; for example, they may be the two teeth either side of the target tooth. The one or more exposed teeth can, for example, be used as landmarks or fiducials that assist the robotic dental system in automatically determining the position and/or orientation of its end effector relative to the target tooth. Because the tooth clamp maintains the target tooth and the one or more exposed teeth in a fixed relative arrangement, these landmarks/fiducials can be relied upon by the robotic dental system for substantially the entire period of time that the clamp is clamped onto the group of teeth of the subject.

### Definitions

As used herein, the following terms shall have the following meanings, unless context indicates otherwise.

As used herein, the terms “rigidly coupled” and “rigidly connected” mean that two (or more) elements are coupled or connected together such that their relative positions and orientations remain fixed.

As used herein, the term “continually” means continuously or repeatedly, although not necessarily in perpetuity. The term continually encompasses periodically and occasionally. Continually generating a signal means generating a continuously varying signal over time or generating a series of (more than one) discrete signals over time. Continually generating a value, such as an error value, means generating a continuously varying value, such as an analog value represented by a continuously varying voltage, or generating a series of (more than one) discrete values over time, such as a series of digital or analog values.

While the invention is described through the above-described exemplary embodiments, modifications to, and variations of, the illustrated embodiments may be made without departing from the inventive concepts disclosed herein. For example, although specific parameter values, such as materials and dimensions, may be recited in relation to disclosed embodiments, within the scope of the invention, the values of all parameters may vary over wide ranges to suit different applications. Unless otherwise indicated in context, or would be understood by one of ordinary skill in the art, terms such as “about” mean within ±20%.

As used herein, including in the claims, the term “and/or,” used in connection with a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

As used herein, including in the claims, an element described as being configured to perform an operation “or” another operation is met by an element that is configured to perform only one of the two operations. That is, the element need not be configured to operate in one mode in which the element performs one of the operations, and in another mode in which the element performs the other operation. The element may, however, but need not, be configured to perform more than one of the operations.

Although aspects of embodiments may be described with reference to flowcharts and/or block diagrams, functions, operations, decisions, etc. of all or a portion of each block, or a combination of blocks, may be combined, separated into separate operations or performed in other orders. References to a “module,” “operation,” “step” and similar terms are for convenience and not intended to limit their implementation. All or a portion of each block, module, operation, step or combination thereof may be implemented as computer program instructions (such as software), hardware (such as combinatorial logic, Application Specific Integrated Circuits (ASICs), Field-Programmable Gate Arrays (FPGAs), processor or other hardware), firmware or combinations thereof.

The controller, etc. or portions thereof may be implemented by one or more suitable processors executing, or controlled by, instructions stored in a memory. Each processor may be a general-purpose processor, such as a central processing unit (CPU), a graphic processing unit (GPU), digital signal processor (DSP), a special purpose processor, etc., as appropriate, or combination thereof.

The memory may be random access memory (RAM), read-only memory (ROM), non-volatile memory (NVM), non-volatile random-access memory (NVRAM), flash memory or any other memory, or combination thereof, suitable for storing control software or other instructions and data. Instructions defining the functions of the present invention may be delivered to a processor in many forms, including, but not limited to, information permanently stored on tangible non-transitory non-writable storage media (e.g., read-only memory devices within a computer, such as ROM, or devices readable by a computer I/O attachment, such as CD-ROM or DVD disks), information alterably stored on tangible non-transitory writable storage media (e.g., floppy disks, removable flash memory and hard drives) or information conveyed to a computer through a communication medium, including wired or wireless computer networks. Moreover, while embodiments may be described in connection with various illustrative data structures, database schemas and the like, systems may be embodied using a variety of data structures, schemas, etc.

Disclosed aspects, or portions thereof, may be combined in ways not listed herein and/or not explicitly claimed. In addition, embodiments disclosed herein may be suitably practiced, absent any element that is not specifically disclosed herein. Accordingly, the invention should not be viewed as being limited to the disclosed embodiments.

As used herein, numerical terms, such as “first,” “second” and “third,” are used to distinguish respective robot arm links, joints, etc. from one another and are not intended to indicate any particular order or total number of links or joints in any particular embodiment. Thus, for example, a given embodiment may include only a second link and a third joint.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A tooth clamp for mounting on, and rigidly clamping to, a plurality of teeth of a subject, the tooth clamp comprising:
a buccal side portion, which is disposed on the buccal side of the plurality of teeth, when the tooth clamp is mounted thereon;
a lingual side portion, which is disposed on the lingual side of the plurality of teeth, when the tooth clamp is mounted thereon;
at least one tightening mechanism, which allows a user to progressively bring the buccal and lingual side portions closer together, to thereby engage the plurality of teeth with a desired amount of clamping force; and
a coupling portion, configured to rigidly couple the clamp to a robotic dental system,
wherein an inwardly-facing side of each of the buccal and lingual side portions comprises an impression portion, which is shaped as an impression of the buccal side and the lingual side, respectively, of the plurality of teeth of the particular subject.

2. The tooth clamp of claim 1, at least part of each impression portion is shaped as an impression of surfaces of the plurality of teeth that are disposed on a gingival side of a height of contour of the plurality of teeth.

3. The tooth clamp of claim 1, wherein the coupling portion is elongate in a length direction that meets the outward-facing surface of the buccal side portion at an oblique or perpendicular angle.

4. The tooth clamp of claim 3, wherein the length direction has a component directed towards the apical direction.

5. The tooth clamp of claim 1, wherein each of the buccal and lingual side portions comprises a frame portion, which holds the impression portion.

6. The tooth clamp of claim 5, wherein each of the buccal and lingual side portions is formed of a first material and each of the impression portions is formed of a second, different material.

7. The tooth clamp of claim 6, wherein the first material is metallic and the second material is polymeric.

8. The tooth clamp of claim 1, wherein at least a majority of an apical side of each of the impression portions is exposed to an exterior of the clamp.

9. The tooth clamp of claim 1, wherein the impression portions are transparent to at least one of: visible light, infrared, or ultraviolet.

10. The tooth clamp of claim 1, further comprising at least one opening, which exposes, to an exterior of the clamp, at least an occlusal surface of at least one tooth of the plurality of teeth.

11. The tooth clamp of claim 1, further comprising a first bridge portion, which connects together the buccal and lingual side portions at either: respective distal ends thereof, or respective mesial ends thereof,
wherein the first bridge portion is generally offset from the buccal and lingual side portions in a coronal direction so that, when the clamp is mounted on the plurality of teeth, the first bridge portion passes over the plurality of teeth.

12. The tooth clamp of claim 11, further comprising a second bridge portion, which connects together the buccal and lingual side portions at respective opposite ends of the buccal and lingual side portions to those connected by the first bridge portion,
wherein the second bridge portion is generally offset from the buccal and lingual side portions in a coronal direction so that, when the clamp is mounted on the plurality of teeth, the second bridge portion passes over the plurality of teeth,
wherein the first bridge portion connects together the buccal and lingual side portions at respective mesial ends thereof, and the second bridge portion connects together the buccal and lingual side portions at respective distal ends thereof, and
wherein a height of the first bridge portion in the coronal direction is less than a height of the second bridge portion in the coronal direction.

13. A robotic dental system, comprising:
the tooth clamp of claim 1;
a robotic arm, a distal end of which is configured to manipulate an end effector; and
a platform, to which a proximal end of the robotic arm is fixed, and to which the tooth clamp is releasably coupled, wherein the coupling of the tooth clamp to the platform maintains the tooth clamp in a fixed position and orientation relative to the platform, and thereby the proximal end of the robotic arm.

14. A method of preparing a plurality of teeth of a subject for a robotic dental procedure, comprising:
providing a tooth clamp for mounting on, and rigidly clamping to, a plurality of teeth of the subject, the tooth clamp comprising:
a buccal side portion, which is disposed on the buccal side of the plurality of teeth, when the tooth clamp is mounted thereon;
a lingual side portion, which is disposed on the lingual side of the plurality of teeth, when the tooth clamp is mounted thereon;
at least one tightening mechanism, which allows a user to progressively bring the buccal and lingual side portions closer together, so that the buccal and lingual side portions thereby engage the plurality of teeth with a desired amount of clamping force; and
a coupling portion, configured to rigidly couple the clamp to a robotic dental system,
wherein an inwardly-facing side of each of the buccal and lingual side portions comprises an impression portion, which is shaped as an impression of the buccal side and the lingual side, respectively, of the plurality of teeth of the particular subject;
mounting the tooth clamp on the plurality of teeth, so that the buccal and lingual side portions are disposed on, respectively, the buccal and lingual sides of the plurality of teeth; and
progressively tightening the tooth clamp, using the at least one tightening mechanism, so that the buccal and lingual side portions thereby engage the plurality of teeth with the desired amount of clamping force.

15. The method of claim 14, further comprising:
applying a hardening filler material, in an unhardened state, to at least one of the buccal or lingual side impression portions;
contacting the plurality of teeth with the hardening filler material in the unhardened state; and
causing the hardening filler material to transition to a hardened state, while the hardening filler material is in contact with the least one of the buccal or lingual side impression portions, and the plurality of teeth.

16. The method of claim 15, wherein said causing of the hardening filler material to transition to a hardened state is prior to said progressive tightening of the tooth clamp.

17. The method of claim 14, further comprising coupling the coupling portion to the robotic dental system.

18. The method of claim 17, further comprising, subsequent to said coupling of the coupling portion to the robotic dental system, registering a dental arch of the subject that comprises the plurality of teeth, with a treatment system of the robotic dental system.

19. A method for carrying out a robotic dental procedure on a subject, comprising:
carrying out the method of preparing a plurality of teeth of a subject for a robotic dental procedure of 17; and
using the robotic dental system to carry out a dental procedure on a target tooth of the subject.

20. The method of claim 19, wherein the plurality of teeth comprises the target tooth.
